(19) United States
(12) Patent Application Publication
(10) Pub. No.: US 2007/0043637 A1
(43) Pub. Date: Feb. 22, 2007

(54) System for automatically tallying time spent by medical personnel attending to patients

(75) Inventors: Luis Garcia, Slinger, WI (US); Bryan D. Dickerson, Hartford, WI (US); Michael D. Cook, Watertown, WI (US); Nathan A. Schleifer, Grafton, WI (US)

Correspondence Address: QUARLES & BRADY LLP, 411 E. WISCONSIN AVENUE, SUITE 2040, MILWAUKEE, WI, 53202-4497, US

(73) Assignee: API Software, Inc.

(21) Appl. No.: 11/207,446

(22) Filed: Aug. 19, 2005

(51) Int. Cl. G07C 1/10; G06F 17/40

(52) U.S. Cl. 705/32; 702/187

(57) ABSTRACT

A monitoring system in a medical facility provides identification devices to patients and a data acquisition device to health care workers. The data acquisition device receives a signal from the identification device which identifies the associated patient and measures an amount of time that the patient is being treated by the health care worker associated with the given data acquisition device. A data interrogator reads data from the data acquisition devices which identify associated health care worker the patients that were treated and the amount of time each treatment. The data read from the data acquisition devices can be used to prepare reports specifying the amount of treatment each patient received and the amount of treatment each health care worker provided.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to time and attendance systems for monitoring employee work hours at a medical facility, and more particularly to a computer system which determining staffing requirements to assist in scheduling employees.

2. Description of the Related Art

The number of employees necessary to properly treat medical patients in a medical facility, such as a hospital, is directly related to the number of such inpatients and the acuteness of their ailments. For a given hospital nursing unit, more registered nurses, licensed practical nurses, orderlies and other health care workers are required when more patients are present or when patients have medical conditions that require extensive personal monitoring and treatments.

Various systems have been developed for assessing the acuity of a patient. For example, a numerical scale can be employed to denote the level of acuity in a manner that is directly related to the level of care that the particular patient requires. Therefore, the higher the numerical acuity level the more intense amount of nursing care is required. However, the acuity assessment requires that a trained person review each patient's current condition and manually assign a numerical acuity level. The assessment has to be evaluated periodically and changed as each patient's condition improves or deteriorates. Thus previous acuity assessment was relatively labor intensive.

Medical facility employee scheduling has manually taken the patient census and general care needs into account when determining how many employees are required to staff a treatment unit during a particular work shift. Because manual scheduling also is a time consuming process in which that numerous parameters must be taken into account, that process typically did not factor in each patient's acuity and thus did not provide the most economical and efficient allocation of medical personnel.

Recently computerized employee scheduling programs have been developed to assign workers to different work shifts during a future wage period. Commonly available systems take into account general staffing needs for different classes of workers, availability and qualifications of particular employees and specific rules, such as for overtime and contractual compensation. The resultant schedule is printed and provided to each employee prior to commencement of that wage period, thus informing the employee when to report to for work and the duration of each work assignment.

More recently an employee scheduling computer program was developed that factors in patient population and acuity to project employee staffing requirements. As a result of this computer program, it became desirable to provide a mechanism that automated the determination of treatment demands that each patient places on medical staff and the treatment levels needed at each unit of the medical facility.

In addition, medical facilities desire methods of measuring the quality of care provided to the patients. To that end it would be desirable to provide a system for automatically recording the length of time that medical workers actually spend attending to each patient as that amount of time has a direct relationship to the quality of care. Knowing the amounts of time that different levels of employees (physicians, nursing supervisors, regular nurses, nursing aids, etc.) spend with patients also is useful in determining the level of care provided to a particular patient. The compilation of this treatment information is valuable is justifying compensation from insurance companies and governmental medical care programs. The same system for automatically recording the length of time spent attending to patients also is useful in evaluating the career progress of interns and other health care workers.

### SUMMARY OF THE INVENTION

An apparatus automatically tallies time spent by a health care worker attending to a patient. That apparatus includes an identification device to be carried by the patient and a data acquisition device to be carried by the health care worker. The identification device emits a first wireless signal that provides an identification of the patient. The data acquisition device receives the first wireless signal and measures an amount of time determined from receipt of the first wireless signal. Preferably the amount of time that the first wireless signal continues to be received is measured as that time indicates how long the health care worker attends to the patient. A data interrogator obtains the amount of time and the identification of the patient from the data acquisition device. This obtained information can be used to determine the level of treatment required by the patient and thus the demands placed on the medical staff.

In one embodiment of the apparatus the identification device emits the first wireless signal periodically regardless of whether the data acquisition device is close by. In another embodiment, the identification device only emits the first wireless signal in response to a second wireless signal transmitted by the data acquisition device.

A unique identifier may be assigned to the data acquisition device which identifier is transmitted to the data interrogator to identify the health care worker carrying device.

The apparatus may also comprise a computer connected to the data interrogator to prepare reports using information acquired from the data acquisition device. Such reports may indicated duration of treatments that the patient received and the amount of treatment that the health care worker administered.

### BRIEF DESCRIPTION OF THE DRAWINGS

FIG. 1 is a schematic diagram of a hospital computer network which stores patient records, as well as information about hospital employees;

FIG. 2 depicts a physician attending to a patient, wherein a data acquisition device carried by the physician records the length of time of that visit;

FIG. 3 is a block schematic diagram of an electronic identification device worn by the patient;

FIG. 4 is a block schematic diagram of the data acquisition device carried by the physician;

FIG. 5 illustrates the physician adjacent a personal computer connected to hospital network and the transfer of data from data acquisition device into the computer;

FIG. 6 is a block schematic diagram of data interrogator connected to a personal computer in the hospital;

FIG. 7 is a graphical representation of data fields of a treatment event record stored within the hospital computer network;

FIG. 8 is a block schematic diagram of another embodiment of an electronic identification device worn by the patient; and

FIG. 9 is a block schematic diagram of another embodiment of a data acquisition device worn by the physician.

### DETAILED DESCRIPTION OF THE INVENTION

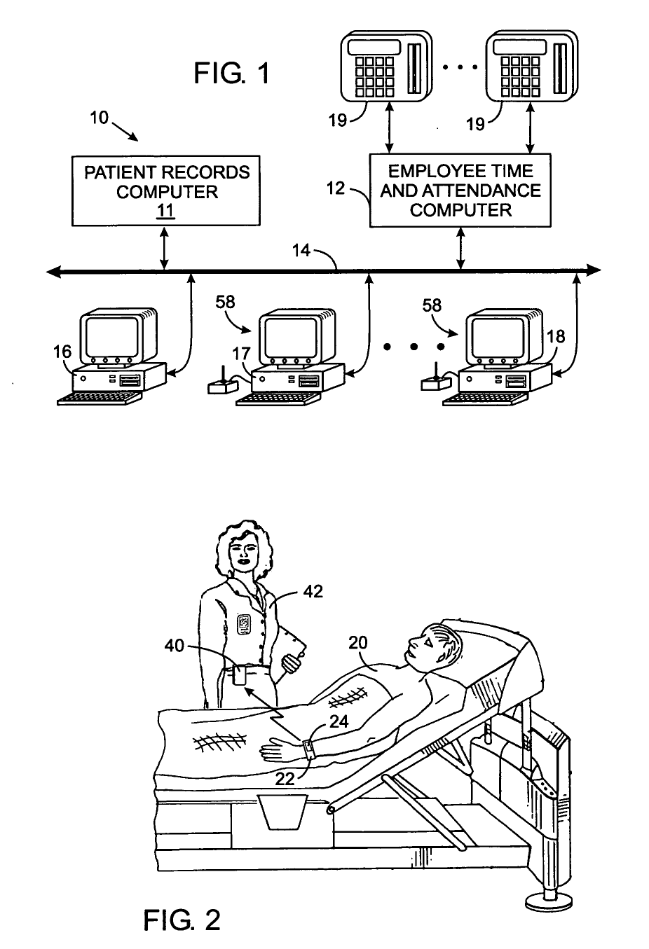

FIG. 1 illustrates a computer network 10 of a hospital. Although the present invention is being described in the context of a hospital, the inventive concepts can be applied to other patient care facilities, such as clinics, nursing homes and extended care facilities for example. The computer network 10 includes a computer 11 that processes and stores patient records and a time and attendance (T&A) computer 12 which executes software programs that schedule work periods for employees and then records the actual amounts of time each employee works. The patient records computer 11 and the time and attendance computer 12 are connected to a conventional local area network (LAN) 14 of a type commonly found in work places. A plurality of personal computers 16, 17 and 18 are connected to the local area network 14 to exchange data and commands with the computers 11 and 12. It should be understood that many more personal computers than are illustrated are connected to the LAN 14 throughout the hospital. For example, personal computers are located at nursing stations, treatment areas and many offices.

For processing employee time and attendance data, a plurality of badge readers 19, through which employees indicate when they start and end periods of work, are located throughout the hospital and are connected to the local area network 14. The badge readers 19 can take any of a number of commercially available forms. For example, each employee is issued an identification badge (e.g. badge 13 in FIG. 2) that has a magnetic strip which encodes a unique employee number and the magnetic strip is read when the employee swipes the identification badge through a slot of a badge reader 19. Each badge reader also has a keypad by which an employee number or other information can be entered into the time and attendance computer 12. A display screen on each badge reader 19 presents information to the employee.

When a patient enters the hospital, an admissions office employee inputs information into the patient records computer 111 via one of the personal computers 16. This process creates a record for that patient for this particular visit within the memory of the patient records computer 11. That record contains standard information, such as the patient's name, address, biographical information, billing information, physicians' names and the like. As is conventional practice in most medical facilities, the personal computer 16 prints a label 15 for a wristband that is worn by the patient to provide identification to health care workers.

However unlike prior practice, the label 15 now is attached to a wristband 22, that contains an electronic identification device 24 which emits a radio frequency signal carrying a unique identification number for this patient, as represented in FIG. 2. Although the exemplary identification device 24 is being described as attached to a wristband 22 fastened around the lower forearm of the patient 20, it should be understood that the identification device may be worn about other parts of the patient's body or take other forms.

The identification device 24 may be preprogrammed with an identification number which may be the same as or different than the standard number assigned to the hospital patients for billing and other purposes. That identification (ID) number also is imprinted in human readable form on the wristband, so that it can be entered into the personal computer 16 and stored in the data file in the patient records computer 11 for this patient. Alternatively the patient identification number may be programmed into the identification device 24 by the personal computer 16 in the admissions office thereby enabling a single number to be used for all identification purposes. In that latter case the personal computer may download other information about the patient, such as allergies, into the identification device.

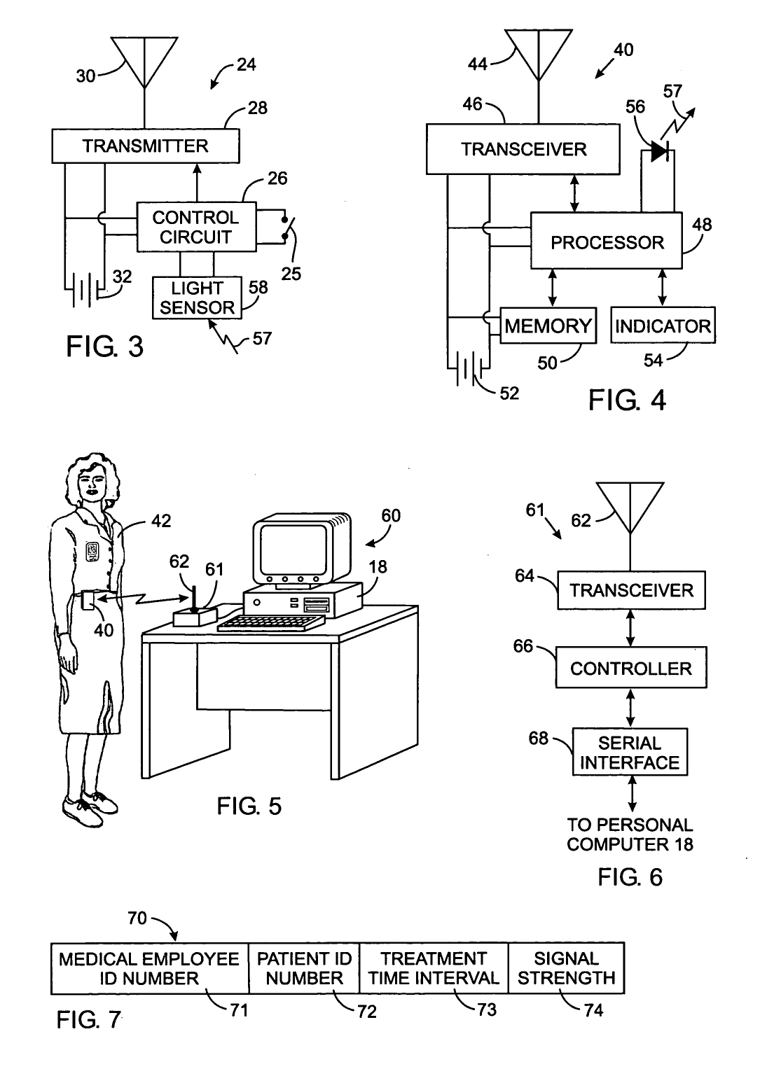

With reference to FIG. 3, the electronic identification device 24 in the wristband 22 has a control circuit 26 which governs the operation of the device and has the unique patient identification number stored therein. A switch 25, connected to the control circuit, is used to activate the identification device upon being issued to a patient. When activated, the control circuit 26 periodically sends the patient identification number to a radio frequency (RF) transmitter 28 which thereby becomes activated. The transmitter 28 modulates an RF carrier signal with the patient identification number using any standard modulation technique. The resultant first radio frequency signal is applied to an antenna 30 from which the signal radiates in an omnidirectional pattern. The components of the identification device 24 are powered by a battery 32.

Referring again to FIG. 2, while the patient 20 is within the hospital, the identification device 24 periodically transmits the first radio frequency signal 21 containing the associated patient identification number. The health care workers in the hospital wear data acquisition devices 40 that receive the first RF signal while attending to the respective patient. For example, the data acquisition device 40 can be worn on the belt or waistband of a health care worker 42, such as a physician, nurse, or laboratory technician, for example. The first RF signal from the patient's identification device 24 has an effective signal strength within only a few feet around the patient 20. Beyond that limited range the data acquisition devices 40 will not detect that first RF signal. Therefore, for the data acquisition device of a given hospital worker to pick-up a patient's identification number, that worker must be relatively close to the patient. That limited RF signal range reduces the likelihood of a data acquisition device 40 simultaneously receiving signals from two patients in a semi-private hospital room or in close proximity to each other in other treatment areas of the hospital. In addition, the data acquisition device 40 is configured so that as long as a signal continues to be received from one identification device 24, as determined based on the patient identification number carried by that signal, all signals from other identification devices will be ignored.

The data acquisition device 40 also may measure the strength of the RF signal received from the identification device 24 as indicating the proximity of the hospital worker to the patient. The RF signal strength can be employed to differentiate between signals that are received simultaneously from two or more identification devices 24 and select the strongest signal as likely received from the patient being treated. Even when only a single relatively weak RF signal, i.e. one having a signal strength below a defined threshold, is received, that signal may be ignored as likely originating from a patient who merely is near the medical worker and is not being treated. The RF signal strength also indicates the level of treatment being administered, as a relatively high level denotes very close proximity between the hospital worker and the patient, whereas a lower level may result from the worker merely is looking in on the patient.

With reference to FIG. 4, the data acquisition device 40 includes an antenna 44 that is connected to a transceiver 46 which has a receiver section and a transmitter section. Upon receiving a first RF signal from a patient identification device 24, the transceiver section demodulates that signal and extracts the patient identification number. The patient identification number then is transferred to a processor 48 from which it is stored in a memory 50 of the data acquisition device 40. The processor executes a software program that also is stored in the memory 50 and which controls the operation of the data acquisition device. An indicator 54 is connected to the processor 48 and may comprise indicator lights or a liquid crystal display for presenting information about the operation of the data acquisition device to the wearer. A battery powers the components of the data acquisition device 40.

When a health care worker 42 approaches a patient 20 as shown in FIG. 2 and the data acquisition device 40 begins receiving the patient identification number, the processor 48 starts a software based timer which measures the interval at which the health care worker attends to the particular patient 20. That timer continues to run as long as the data acquisition device 40 continues to receive periodically a first radio frequency signal 21 containing the same patient identification number. Since the patient identification device 24 transmits the first radio frequency signal at a known interval, if a defined number of intervals pass without receiving a radio frequency signal, the data acquisition device 40 concludes that a health care worker 42 no longer is attending to a patient. Upon reaching that determination, the processor 48 terminates the timer and stores the timer's final value into a location in memory 50 that is associated with the most recently received patient identification number. Thus, the memory 50 now contains an indication of the patient 20 and the duration of that person's recent treatment.

If the health care worker 42 returns to attend to the same patient, a new set of storage locations within memory 50 are employed to retain the patient's identification number and another treatment time interval. When that same health care worker 42 is in the vicinity of other patients, their respective identification numbers are obtained from the first radio frequency signal transmitted by their identification devices 24 and stores along with the treatment time interval. Over the course of time, the data acquisition devices 41 worn by each health care worker 42 who attends to patients will contain the patient identification numbers for a plurality of patients along with the times that the workers attended to each of those patients.

Other information stored in the patient identification device 24 also is transmitted to the data acquisition device 40 along with the identification number. For example, information indicating allergies of the patient can be presented to the hospital worker on a indicator 54 of the data acquisition device 40. The data acquisition device also may received data, such as temperature and heart rate, from portable monitors carried by the patient. Such data is stored in the data acquisition device 40 for subsequent transfer to the patient records computer 11, as will be described.

The patient identification device 24 periodically transmitting the identification number consumes battery power even though a hospital employee is not attending to the patient, which is the vast majority of the time for the typical patient. As a modification to conserve power, the data acquisition device 40 can include am infrared light emitter, such as LED 56. The processor periodically activates the light emitter which produces a wide beam 57 of infrared light. The patient identification device 24 includes an infrared light sensor 58 that responds to receiving the beam 57 from the data acquisition device 40 by commencing periodic transmission of the patient identification number. Those transmission continue until the light beam no longer is received.

The data stored in the data acquisition devices 40 are transferred to various personal computers 17 and 18 which are located throughout the hospital on the local area network 14 in FIG. 1 and configured as patient information transfer stations 60. With reference to FIGS. 5 and 6, personal computer 18 is connected to a data interrogator 61 which acquires the stored information from the data acquisition device 40 and conveys that information to the personal computer.

The interrogator 61 has an antenna 62 that is connected to a transceiver 64 which exchanges command and data with a controller 66 and passes that data through as serial interface 68 to the personal computer 18. Periodically such as every second or two, the interrogator 61 transmits a radio frequency signal carrying an interrogation command. When a health care worker 42 carrying a data acquisition device 40 is within approximately ten feet of the interrogator 61, the data acquisition device 40 responds to the interrogation command. Specifically, the interrogation command is extracted from the received radio frequency signal by the transceiver 46 in the data acquisition device 40 and sent to the processor 48 (see FIG. 4). Upon receiving an interrogation command, the processor 48 executes a software routine which reads memory 50 to obtain a unique identification number that was assigned to the associated data acquisition device 40. This latter identification number identifies the particular data acquisition device 40 and the health care worker to whom the device was issued. Thus the identification number assigned to the data acquisition device 40 is referred to as a health care worker identification number. As used herein, the terms “patient identification number” and “health care worker identification number” refer generically to identifiers that may contain only numerals, only alphabetic characters, or a combination of alphanumeric characters, as well as other characters. The health care worker identification number is sent to the transceiver 46 which modulates a radio frequency carrier with that number and applies the resultant radio frequency signal to the antenna 44. Then the software routine being executed by the processor 48 sequentially acquires the sets of a patient identification number and a treatment time interval stored within memory 50. Those sets of data are transferred to the transceiver 46 which sends that data via the radio frequency signal to the antenna 44. Thus, the data acquisition device 40 responds to the interrogation command by transmitting a return signal that contains its health identification number and the patient identification and treatment time information stored within the memory 50.

That return signal is received by the interrogator antenna 62 and applied to the receiver section of the transceiver 64 in FIG. 6. The transceiver 64 demodulates the received signal extracting the information carried by the return signal. The health care worker identification number and each set of a patient identification number and treatment interval time are transferred through the serial interface 68 to the personal computer 18. The personal computer temporally stores the information received from the data acquisition device as a series of treatment event records 70, one of which is represented in FIG. 7. Each treatment event record 70 comprises four data fields 71, 72, 73 and 74 that respectively contain the health care worker identification number, a patient identification, a treatment time interval, and a measurement of the strength of the RF signal from the patient's identification device 24.

Alternatively, the data interrogator may comprise a cable connected to the personal computer 18 and a software routine that is executed by that personal computer. The cable is connected temporarily to the data acquisition device 40. The software routine issues the interrogation command via the cable to the data acquisition device and obtains the patient treatment information. Other types of data interrogators that perform this function can be employed.

As a further alternative, the data interrogators comprise a plurality of wireless data collection nodes connected to the computer network 10 and using technology similar to wireless Internet access. Those data collection nodes are located in hallways throughout the areas of the hospital in which patients are treated so that the medical worker's data acquisition device 40 always will be within range of at least one node. Now, as the data acquisition device 40 completes timing a patient visit by the respect hospital worker, the associated data is immediately transmitted to wireless data collection nodes.

After all of the patient treatment information has been acquired from the data acquisition device 40, the personal computer 18 or wireless data collection node transfers that information over the computer network 14 to the patient records computer 11. The patient records computer 11 parses the treatment information from a given data acquisition device 40 based on the patient identification numbers and stored that information in separate data records for each patient. The record for each patient then has data showing which health care worker treated that patient and the duration of each treatment. This patient treatment information then can be analyzed to determine the total time of treatment for each patient and the amounts of time that the particular patient was treated by each of several classes of health care workers, such as physicians, nurses, nursing assistants, orderlies, X-ray technicians, etc. The general patient information stored in the patient records computer 11 designated the nursing unit to which an inpatient is assigned. This enables the acquired treatment information to be further analyzed to determine the magnitude of nursing care being provided at each nursing unit and thus project staffing requirements.

The patient treatment information also is transferred to the employee time and attendance computer 12 which tabulates the information based on the health care worker identification number associated with each treatment event record 70 from the data acquisition devices 40. Thus, a record for a particular health care worker stored within the memory of the time and attendance computer 12 contains information identifying each patient that the respective health care worker treated and the amount of time of such treatments. This information can be analyzed to determine the total amount of treatment provided by a particular health care worker. The employee records in the time and attendance computer 12 may specify that a given health care worker is assigned to a particular hospital treatment unit, such as a given nursing unit, the emergency room, medical imaging facility, physical therapy department, and the like. That health care worker data along with the patient treatment information enables analysis of the patient care provided at each hospital treatment unit.

For example the acquired data for a particular employee can be analyzed to determine whether that person is attending to patients to whom he or she is not assigned. The treatment data also can be analyzed to track the progress and the experiences of a physician intern or other employee in training.

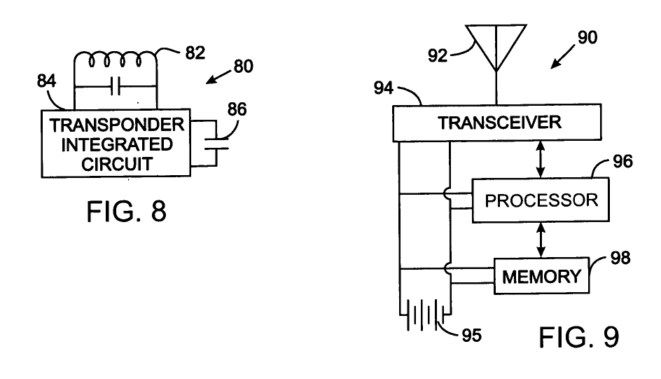

FIG. 8 depicts second type of electronic patient identification device 80 for incorporation into the wristband 22 of the patient 20. This second identification device is passive in that it does not require a power source, such as a battery. Instead, the second patient identification device 80 comprises a conventional radio frequency transponder tag, such as the type that is commonly used to identify products or used as a key-card of a building entry system. The second patient identification device 80 has an antenna 82 that is part of a tuned, resonant circuit connected to a transponder integrated circuit 84 which may be any one of a number of commercially available devices, such as one of a family of products available from Texas Instruments Incorporated, Dallas, Tex., USA. The transponder integrated circuit 84 is powered by energy derived from a radio frequency signal received at antenna 82 and used to store a charge on a capacitor 86. That stored charge provides a voltage for powering the electronic circuits. Because the second patient identification device 80 does not require power from a battery, it can be utilized with patients requiring long term care or who will be permanent residents of a nursing facility.

The second patient identification device 80 is used in conjunction with a second type of data acquisition device 90 represented in FIG. 9 and carried by a health care worker 42. That second data acquisition device 90 has an antenna 92 which is connected to a radio frequency transceiver 94. The transceiver 94 exchanges data with and is controlled by a processor 96 that interfaces with a memory 98. The components of the data acquisition device 90 are powered by a battery 95.

A second data acquisition device 90 periodically, every second or so, emits a second radio frequency signal that has an effective range of approximately ten feet extending radially from the antenna 92. When a second patient identification device 80 is within in that effective range, the transponder integrated circuit 84 becomes energized by power derived from that second radio frequency signal. In response to the receipt of a second radio frequency signal, the second patient identification device 80 replies by emitting the first radio frequency signal that carries the unique patient identification number that is stored within the transponder integrated circuit 84. Upon receiving a valid reply from a second patient identification device 80, the transceiver 94 demodulates that reply signal, extracting the unique patient identification number. That number is that passed to the processor 96 which stores it in a location in memory 98. Upon the receiving a different patient identification number, the processor 96 starts a timer in a similar manner to that described previously with respect to the first data acquisition device 40. The timer continues to run as long as the second data acquisition device 90 continues to receive replies from a transponder. When the replies cease, the processor 96 stops the timer and records the final value within a location in memory 98 that is associated with the respective patient identification number. This process is repeated each time the data acquisition device 40 receives a reply from a different transponder type second patient identification device 80.

In close proximity to a data interrogator 61, the second data acquisition device 90 receives an interrogation command carried by the radio frequency signal from the data interrogator. The second data acquisition device 90 responds to the interrogation command by transferring its health care worker identification number and the acquired patient treatment data from the memory 98 to the data interrogator 61 in the same manner as described previously with respect to the first data acquisition device 40. The patient treatment data is conveyed to the patient records computer 11 and the time and attendance computer 12 for storage and analysis also as described above.

The foregoing description was primarily directed to preferred embodiments of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. An apparatus for automatically tallying time spent by a health care worker attending to a patient, said apparatus comprising:
an identification device located proximate to the patient and emitting a first wireless signal that provides an identification of the patient;
a data acquisition device to be carried by the health care worker, the data acquisition device receiving the first wireless signal, and measuring an amount of time determined from receipt of the first wireless signal; and
a data interrogator which obtains the amount of time and the identification of the patient from the data acquisition device.

2. The apparatus as recited in claim 1 wherein the first wireless signal carries a unique identification number.

3. The apparatus as recited in claim 1 wherein the identification device emits the first wireless signal periodically.

4. The apparatus as recited in claim 1 wherein:
the data acquisition device transmits a second wireless signal; and
the identification device responds to receiving the second wireless signal by emitting the first wireless signal.

5. The apparatus as recited in claim 1 wherein the data acquisition device stores the amount of time and an identification of the patient; and the data interrogator obtains the amount of time and an identification of the patient that are stored in the data acquisition device.

6. The apparatus as recited in claim 1 wherein the data interrogator obtains the amount of time and an identification of the patient from the data acquisition device via a wireless signal.

7. The apparatus as recited in claim 1 wherein the data interrogator sends an interrogation command to the data acquisition device, and the data acquisition device responds to the interrogation command by transmitting the amount of time and an identification of the patient to the data interrogator.

8. The apparatus as recited in claim 7 wherein the data acquisition device is assigned an identification number and further responds to the interrogation command by transmitting identification number to the data interrogator.

9. The apparatus as recited in claim 1 wherein the data acquisition device is assigned an identification number and the data interrogator also obtains the identification number from the data acquisition device.

10. The apparatus as recited in claim 1 wherein the amount of time measured by the data acquisition device is derived from a time interval that the first wireless signal continues to be received from the identification device.

11. The apparatus as recited in claim 1 further comprising a computer that is connected to the data interrogator and that prepares a patient treatment report using the amount of time and an identification of the patient.

12. An apparatus for automatically tallying time spent by health care workers attending to patients, said apparatus comprising:
a plurality of identification devices one of which being assigned to each patient and each identification devices emitting a first wireless signal that provides an identification of the patient to whom the respective identification device was assigned;
a plurality of data acquisition devices one of which being assigned to each health care worker for receiving the first wireless signal and containing an identifier of a given health care worker, whenever a first wireless signal is received a given data acquisition device measures an amount of time that such first wireless signal continues to be received and stores data record specifying the identification of the patient and the amount of time; and
at least one data interrogator which obtains from plurality of data acquisition devices the data record stored therein and the identifier of the given health care worker.

13. The apparatus as recited in claim 12 wherein each identification device periodically transmits the first wireless signal.

14. The apparatus as recited in claim 12 wherein:
each data acquisition device transmits a second wireless signal; and
each identification device responds to receiving the second wireless signal by emitting the first wireless signal.

15. The apparatus as recited in claim 12 wherein each data interrogator sends an interrogation command, and each data acquisition device responds to the interrogation command by transmitting the data record and the identifier of a given health care worker.

16. The apparatus as recited in claim 12 further comprising a computer that is connected to the data interrogator and that prepares a patient treatment report using the data records and the identifier of a given health care worker obtained from the plurality of data acquisition devices.

17. The apparatus as recited in claim 12 further comprising a computer that is connected to the data interrogator and that prepares a health care worker treatment report using the data records and the identifier of a given health care worker obtained from the plurality of data acquisition devices.

18. A method for automatically tallying time spent by a health care worker attending to a patient, said apparatus comprising:
the patient carrying an identification device that emits a first wireless signal which provides an identification of the patient;
the health care worker carrying a data acquisition device that receives the first wireless signal, and measures an amount of time determined from receipt of the first wireless signal; and
obtaining, via a data interrogator, the amount of time and the identification of the patient from the data acquisition device.

19. The method as recited in claim 18 wherein the first wireless signal carries a unique identification number.

20. The method as recited in claim 18 wherein the identification device periodically transmits the first wireless signal.

21. The method as recited in claim 18 further comprising the data acquisition device transmitting a second wireless signal; and wherein the identification device emits the first wireless signal in response to receiving the second wireless signal.

22. The method as recited in claim 18 further comprising storing the amount of time and an identification of the patient in the data acquisition device.

23. The method as recited in claim 18 further comprising the data interrogator sending an interrogation command to the data acquisition device, and the data acquisition device transmitting the amount of time and an identification of the patient to the data interrogator in response to receiving the interrogation command.

24. The method as recited in claim 23 further comprising assigning an identification number to the data acquisition device; and the data acquisition device transmitting the identification number to the data interrogator in response to receiving the interrogation command.

25. The method as recited in claim 18 wherein the data acquisition device measures an amount of time amount of time measured by measuring a time interval that the first wireless signal continues to be received from the identification device.

26. The method as recited in claim 18 further comprising preparing a patient treatment report using the amount of time and an identification of the patient.

27. The method as recited in claim 18 further comprising preparing a health care worker treatment report using the amount of time and an identification of the patient.
